(19) United States
(12) Patent Application Publication
(10) Pub. No.: US 2011/0171934 A1
(43) Pub. Date: Jul. 14, 2011

(54) METHOD OF PROVIDING COMMUNICATION FUNCTION FOR COMMUNICATION GROUP, AND MOBILE COMMUNICATION TERMINAL AND PRESENCE SERVER FOR THE SAME

(75) Inventors: Joohwan Lim, Seoul (KR); Youngmin Son, Seoul (KR); Hyeonjeong Kim, Seoul (KR); Gidong Kim, Seoul (KR); Wooyong Choi, Seoul (KR); Saeyl Park, Seoul (KR)

(73) Assignee: SK TELECOM CO., LTD., Seoul (KR)

(21) Appl. No.: 12/737,625

(22) PCT Filed: Jul. 6, 2009
(86) PCT No.: PCT/KR2009/003676

§ 371 Date: Mar. 31, 2011

(30) Foreign Application Priority Data
Jul. 30, 2008 (KR) 10-2008-0074789
Aug. 4, 2008 (KR) 10-2008-0076167

(51) Int. Cl. H04W 4/12; H04W 88/04

(52) U.S. Cl. 455/412.1; 455/566; 455/466

(57) ABSTRACT

A method for providing communication functions for frequent contacts, and a mobile communication terminal and a presence server for the same are disclosed. The mobile communication terminal includes: a storage for storing a communication program for registering frequent contacts; a display for outputting the communication program; a key input unit for receiving an input of a key or a command; and a controller for executing the communication program to display icons of members registered with the frequent contacts, output a list of contact function icons for a selected member in the frequent contacts, and perform the contact function corresponding to a contact function selection from an updated list of the contact function icons with respect to a selected member, wherein the updated list includes an added or changed contact function that is made in a contact function edit mode.

### TECHNICAL FIELD

The present disclosure relates to a method for providing communication function information for frequent contacts, and a mobile communication terminal and a presence server for the same. More particularly, the present disclosure relates to a method for providing communication functions for frequent contacts, and a mobile communication terminal and a presence server for the same, wherein an icon list of contact functions in which a user of the terminal may contact with a selected member of preregistered frequent contacts on an idle screen of the terminal, is editable with an addition, deletion, or correction, wherein upon receiving a message for added contact function from a server, an application of the add or update mode to the icon list of contact functions additionally facilitates contacting with the members, and wherein the presence server stores communication information about the frequent contact members until it sends them to an alternation terminal replacement, whereby the user is always current with frequent contact information supplied.

### BACKGROUND ART

The statements in this section merely provide background information related to the present disclosure and may not constitute prior art.

The present time advancement of computer, electronics, and communication technologies has enabled a variety of wireless communication services with the help of wireless networks followed by the wide distribution of mobile communication terminals to the general public.

In general, the mobile communication terminals provide the home screen or idle screen on which a user may start various functions, and such idle screen is set to show a manufacturer's default image or menu at its release.

The idle screens and menu screens are still mostly rigid with fixed icons, fonts, and layouts by terminal manufactures or terminal models and the users should accept the setting over their preferences short of individualizing the menu screen.

Meanwhile, most mobile service users consume sixty percent of the total call volume communicating with four lines in their circles. That is, most callers have frequent contacts of four members.

However, with conventional mobile communication terminals, majority users to call the frequent contacts are either required to press a send button to bring up a recent call list to select the desired phone number or directed to pick a button for sending short message before being able to search or input the phone number of the callee which is cumbersome.

### DISCLOSURE

### Technical Problem

Therefore, the present disclosure has been made for offering a method for providing communication functions for frequent contacts, and a mobile communication terminal and a presence server for the same, wherein an icon list of contact functions is editable with an addition, deletion, or correction, and wherein communication information about the frequent contact members is stored until it is supplied to the user.

### Technical Solution

One aspect of the present disclosure provides a mobile communication terminal including: a storage for storing a communication program for registering frequent contacts; a display for outputting the communication program; a key input unit for receiving an input of a key or a command; and a controller for executing the communication program to display icons of members registered with the frequent contacts, output a list of contact function icons for a selected member in the frequent contacts, and perform the contact function corresponding to a contact function selection from an updated list of the contact function icons with respect to a selected member, wherein the updated list includes an added or changed contact function that is made in a contact function edit mode.

Another aspect of the present disclosure provides a presence server including: a server communicator interworking with mobile communication terminals sharing common mobile communication subscriber information but having different terminal identification numbers; a server controller for receiving and storing a presence message containing communication information on a current status from a first mobile communication terminals, generating latest communication information by receiving an updated presence message containing an update of the current status from the first mobile communication terminals and by applying the update to previously stored communication information, and transmitting a presence response signal containing the latest communication information to a second mobile communication terminal upon receiving a presence request signal from the second mobile communication terminal; and a server storage for storing one or more of the presence message, the communication information, and the latest communication information.

Another aspect of the present disclosure provides a method for providing communication functions in a communication terminal to frequent contacts including: executing a communication program for registering the frequent contacts to display icons of members registered with the frequent contacts; outputting a list of contact function icons for a selected member in the frequent contacts; and performing a contact function corresponding to a contact function selection from an updated list of the contact function icons with respect to a selected member, wherein the updated list includes an added or changed contact function that is made in a contact function edit mode.

### Advantageous Effects

As described above, the present disclosure allows the icon list of contact functions to be edited with an addition, deletion, or correction to facilitate contacting contact members, and keeps communication information about the frequent contact members stored and made available at any time.

In addition, the editing ability on the icon list of contact functions with the addition, deletion, or correction at the user's option provides the user with an option of diverse contact functions as well as an easy communication function with the selected member of preregistered frequent contacts.

In addition, changed icons of contact members or changed user information is applied to latest community information and kept in storage, and thereby have the user's set contact member icon or user information be readily made available to the user.

### DESCRIPTION OF DRAWINGS

FIG. 1 is a schematic block diagram for showing a system for providing a contact function menu according to a first aspect;

FIG. 2 is a schematic block diagram for showing a mobile communication terminal for providing a contact function menu according to the first aspect;

FIG. 3 is a flow chart for illustrating a method for the mobile communication terminal of the first aspect to receive and apply add or update data;

FIG. 4 is a flow chart for illustrating a method for the mobile communication terminal of the first aspect to update and output the contact function menu;

FIGS. 5 and 6 are exemplary diagrams of an idle screen and an active mode screen according to the first aspect;

FIG. 7 is an exemplary diagram of a contact function edit mode according to the first aspect;

FIG. 8 is an exemplary diagram of an updated list of contact function icons according to the first aspect;

FIG. 9 is a schematic block diagram for showing a system for providing a presence service according to a second aspect;

FIG. 10 is a schematic block diagram for showing a presence server according to the second aspect;

FIG. 11 is a schematic block diagram for showing a mobile communication terminal according to the second aspect;

FIG. 12 is a flow chart for illustrating a method for the mobile communication terminal of the second aspect to output contact member information and share status information;

FIG. 13 is a flow chart for illustrating a method for a communication server of the second aspect to share status information;

FIGS. 14 and 15 are a flow chart for showing a method for the presence server of the second aspect to provide the presence service; and

FIGS. 16 and 17 are exemplary diagrams of the mobile communication terminal according to the second aspect.

### MODE FOR INVENTION

Hereinafter, aspects of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

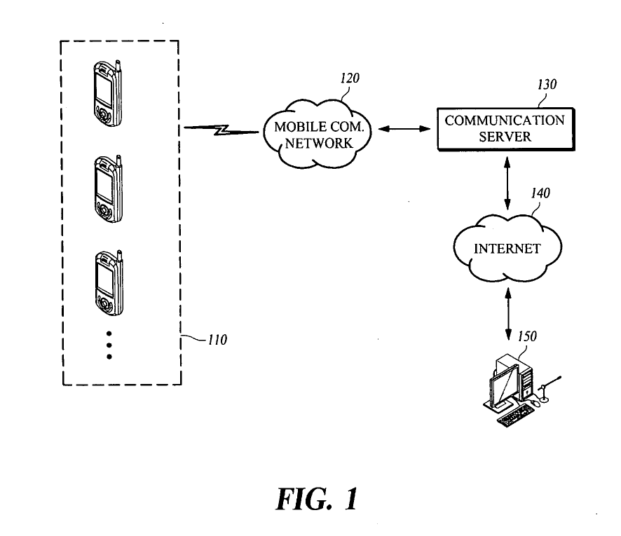

FIG. 1 is a schematic block diagram for showing a system for providing a contact function menu according to a first aspect.

The contact function menu provision system of this aspect includes mobile communication terminals 110, a mobile communication network 120, a communication server 130, Internet 140, and a user terminal 150.

Mobile communication terminal 110 means a terminal for carrying out typical wireless communications of voice call and data communication in association with mobile communication network 120.

Mobile communication terminal 110 may include a personal digital assistant or PDA, a cellular phone, a personal communication service or PCS phone, a hand-held PC, CDMA-2000 phone, a WCDMA phone, a portable multimedia player or PMP, and a mobile broadband system or MBS phone.

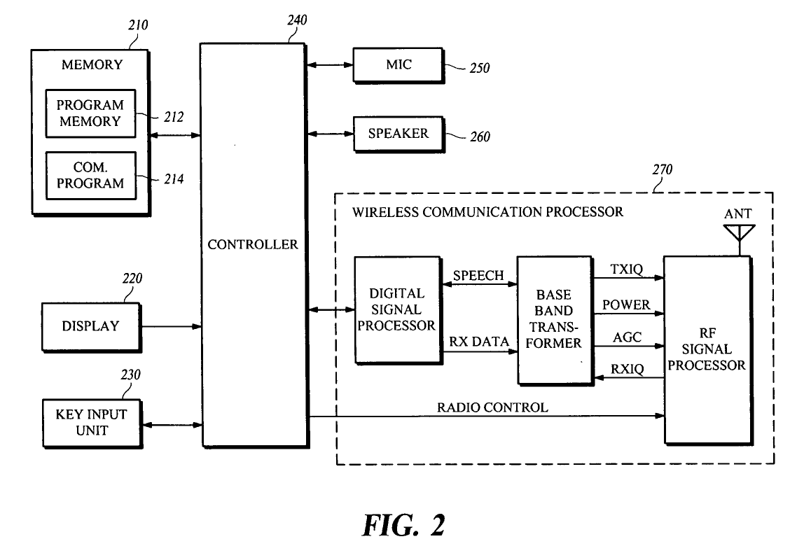

Generally speaking with reference to the drawings throughout, mobile communication terminal 110 of the first aspect, in response to a preset activation key input from a key input unit 230 according to a communication program 214 (FIG. 2), turns to show at least one member icon of frequent contacts 540 on an active mode screen 550; in response to a preset member icon selection key input, outputs a selected member icon among frequent contacts 540 along with an output of a list of contact function icons 530 for the selected member icon; in response to a preset contact function editing key input, outputs a contact function edit mode 710 and then checks if an added or changed menu 810 is present where an updated contact function icon list 820 is outputted with the added or changed menu 810 applied thereto; and in response to a contact function selection key input for updated contact function icon list 820, performs the action plans set with the contact function selection key.

Here, contact function edit mode 710 may include a title area 712, a text area 714, a basic menu list 716, and an optional menu list 718.

Optional menu list 718 may be comprised of a preset number of optional menu slots, to which mobile communication terminal 110 may apply an added or changed menu 810, or the optional menus in the slots may be replaced by added or changed menu 810.

The optional menu slots may comprise optional menus which include a mobile homepage menu, an email menu, a personal homepage, and a PC remote control menu.

Basic menu list 716 may be comprised of a preset number of basic menu slots, to which mobile communication terminal 110 is controlled from applying added or changed menu 810, and basic menus included in the basic menu slots are controlled from being replaced by added or changed menu 810.

In addition, mobile communication terminal 110 outputs updated contact function icon list 820 generated by adding or deleting updated menus resulting from selecting or deselecting basic menus included in the basic menu slots, to and from contact function icon list 530.

The basic menus included in the basic menu slots may be comprised of at least one of a voice call menu, short message service (SSM) menu, multimedia messaging service (MMS) menu, data format type message menu, a multimedia instant message (MIM) menu.

Mobile communication terminal 110 of the first aspect receives a message of the added contact functions from communication server 130, checks the same message at its data field to see if there is an add or update contact function, and in response to such function added or updated, receives and stores additional/updated data for the add or update contact function.

Mobile communication terminal 110 of the first aspect additionally outputs a menu icon of the additional/updated data onto optional menu list 718.

The message of the added contact functions includes a data field incorporating added contact function identification information which may comprise information of at least one of Activate Talk Function, Activate Connection to Internet, Activate SMS, Activate MMS, and Activate Application.

Mobile communication terminal 110 outputs updated list of icons of contact functions comprised of frequently selected menus for a selected member icon.

Mobile communication terminal 110 outputs an idle screen 510, and operates on communication program 214 to output at an area of idle screen 510 a thumbnail group 520 having thumbnails 522 by the corresponding amount to the preset slots.

Mobile communication terminal 110, in response to a preset activation key from key input unit 230, outputs active mode screen 550 for indicating member icons of at least one member of frequent contacts 540 matching with thumbnail group 520.

Mobile communication terminal 110 outputs on the active mode screen user's own information added to frequent contacts 540. Here, the user information includes one or both of user image information 620 and user name information 630:

On the active mode screen, mobile communication terminal 110 displays identifier information 640 for differentiating user's own information from the preregistered member icons with frequent contacts 540.

Here, the user's own information includes one or more of user's own image information 620, name information 630, and status change information (not shown) which includes an editing function of the user's photo or a changing function of the user's status.

Mobile communication terminal 110 performs rendering of user's own image information 620 in a different borderline color or pattern from preregistered member image information 524 for a further differentiation therebetween.

Mobile communication terminal 110 additionally incorporates a thumbnail 610 for user's own image information into thumbnail group 520.

Mobile communication network 120 means a network connected by wireless with mobile communication terminal 110 for carrying out various functions that allow serving voice call, wireless data, wireless Internet, video call, or messaging communications.

Communication server 130 periodically sends the message of added contact function to mobile communication terminal 110 via mobile communication network 120.

In addition, in response to a connection by mobile communication terminal 110, communication server 130 transmits additional/updated data corresponding to the add or update contact function.

Internet network 140 is a network for transmitting and receiving data using the Internet Protocol through wired/wireless communication technologies, and it relays data transmitted between communication server 130 and user terminal 150.

User terminal 150 means a terminal capable of receiving various web pages via Internet network 140 in response to user's key operations, and it may be a personal computer or PC, notebook or laptop computer, portable information terminal or personal digital assistant (PDA), or mobile communication terminal, and also mean a terminal equipped with a memory for storing a web browser making connections with communication server 130 via Internet network 140 and various programs and a microprocessor for executing the programs to effect operations and controls.

User terminal 150 may take the route of Internet network 140 for connection to communication server 130, output the active mode screen for displaying at least one of icons of members of the frequent contacts after receiving it from communication server 130, and respond to a preset member icon selection key input for receiving and outputting information of a selected member among the frequent contacts.

In addition, user terminal 150, in response to a preset contact function editing key, may output a contact function editing page received from communication server 130, and send added or changed menu 810 if present to communication server 130. That is, communication server 130 may receive added or changed menu 810 from user terminal 150 to transmit the same to mobile communication terminal 110.

FIG. 2 is a schematic block diagram for showing mobile communication terminal 110 for providing a contact function menu according to the first aspect.

Mobile communication terminal 110 includes a memory 210, display 220, key input unit 230, controller 240, microphone 250, speaker 260, and wireless communication processor 270.

Although the presently disclosure recites that mobile communication terminal 110 includes a memory 210, display 220, key input unit 230, controller 240, microphone 250, speaker 260, and wireless communication processor 270, it is only illustrative and the mobile communication terminal components may be applied with changes and modifications as needed by a person skilled in the art.

Memory 210 is a means for storing basic software for driving mobile communication terminal 110 and performing voice and data communications, a number of software programs for carrying out various extra functions including a camera feature, and protocol software for processing messages transmitted and received to perform wireless communications and the like.

Memory 210 temporarily stores data generated throughout executing a terminal control program or stores user's input data, and it may be composed of a program memory 212 for controlling the general operation of mobile communication terminal 110 and a communication program 214 for outputting contact function icon list 530 or updated contact function icon list 820.

Here, communication program 214 is a program capable of selecting, adding, and deleting a menu included in contact function icon list 530, and it will be so called in the following description.

Communication program 214 may be implemented by a computer readable media with a computer program written therein and the program executes functions to, in response to a preset activation key input, refresh into active mode screen 550 for showing at least one member icon of frequent contacts 540; in response to a preset member icon selection key input, output a selected member icon among frequent contacts 540 along with an output of contact function icon list 530 for the selected member icon; in response to a preset contact function editing key input, output a contact function edit mode 710 and then checks if added or changed menu 810 is present where updated contact function icon list 820 is outputted with the added or changed menu 810 applied thereto; and in response to a contact function selection key input for updated contact function icon list 820, perform the action plans set with the contact function selection key.

Display 220 shows the state of operation of mobile communication terminal 110 including the usage of a power source, the strength of the radio signal reception, date, and time, and it becomes a display means for outputting information delivered in the forms of characters, numbers, images, etc.

Following controller 240, display 220 also shows messages generated along the execution of the various programs stored in memory 210 and messages generated through the execution of communication program 214 according to the first aspect.

Input unit 230 is a key input means provided with numerical buttons, character input button, menu selection buttons and the like for receiving key inputs or commands from the user of mobile communication terminal 110.

Controller 240 is to control the overall operation of mobile communication terminal 110 and executes the various programs stored in memory 210 for not only the basic function of voice and data communications according to inputted signals from key input unit 230 or wireless communication processor 270 but also extra functions. In addition, upon receiving data having no immediacy in execution, controller 240 has such data sent to and stored in memory 210.

Controller 240 of the first aspect executes functions to, in response to an input of the preset activation key from key input unit 230, refresh into active mode screen 550 for showing at least one member icon of frequent contacts 540; in response to a preset member icon selection key input, output a selected member icon among frequent contacts 540 along with an output of contact function icon list 530 for the selected member icon; in response to a preset contact function editing key input, output a contact function edit mode 710 and then checks if added or changed menu 810 is present where updated contact function icon list 820 is outputted with the added or changed menu 810 applied thereto; and in response to a contact function selection key input for updated contact function icon list 820, perform the action plans set with the contact function selection key.

Optional menu list 718 may be comprised of a preset number of optional menu slots, to which controller 240 may apply added or changed menu 810, or the optional menus in the slots may be replaced by added or changed menu 810.

Basic menu list 716 may be comprised of a preset number of basic menu slots, and controller 240 limits added or changed menu 810 from being applied to the basic menu slots and also controls the basic menus included in the basic menu slots from being replaced by added or changed menu 810. In addition, controller 240 outputs updated contact function icon list 820 which is contact function icon list 530 with possibly selected or unselected menus applied thereto from the basic menus included in the basic menu slots.

Controller 240 of the first aspect receives the message of the added contact functions from communication server 130 by using wireless communication processor 270, checks the same message at its data field to see if there is an add or update contact function, and in the event of such function added or updated, receives and stores additional/updated data for the add or update contact function from communication server 130.

Controller 240 of the first aspect additionally outputs a menu icon of the additional/updated data onto optional menu list 718.

Controller 240 outputs idle screen 510, and operates on communication program 214 to output at an area of idle screen 510 a thumbnail group 520 having thumbnails 522 by the corresponding amount to the preset slots.

Controller 240, in response to a preset activation key from key input unit 230, outputs active mode screen 550 for indicating member icons of at least one member of frequent contacts 540 matching with thumbnail group 520.

Controller 240 outputs user's own information added to frequent contacts 540 on the active mode screen.

On the active mode screen, controller 240 displays identifier information 640 for differentiating user's own information from the preregistered member icons with frequent contacts 540.

Controller 240 performs rendering of user's own image information 620 in a different borderline color or pattern from preregistered member image information 524 for a further differentiation therebetween.

Controller 240 additionally incorporates thumbnail 610 for user's own image information into thumbnail group 520.

Microphone 250 is a voice input means adapted to transform a mobile communication subscriber's voice input into an electric signal to supply. Speaker 260 is a means for transforming the supplied voice signal into audible sounds to output.

Wireless communication processor 170 is a means for processing wireless communications by performing a digital signal processing function including audio signal coding/decoding, an equalizer feature for canceling a multipath noise, and audio data processing; a baseband transform function including a transform of transmitted/received signals to the baseband signals and a digital-to-analog and analog-to-digital transforms; an RF signal processing function including receiving and transforming a radio frequency (RF) signal to an intermediate frequency (IF) signal, transforming the IF signal to RF signal, and demodulating and amplifying the RF signal; and an antenna function for transmitting and receiving wireless signals over the air.

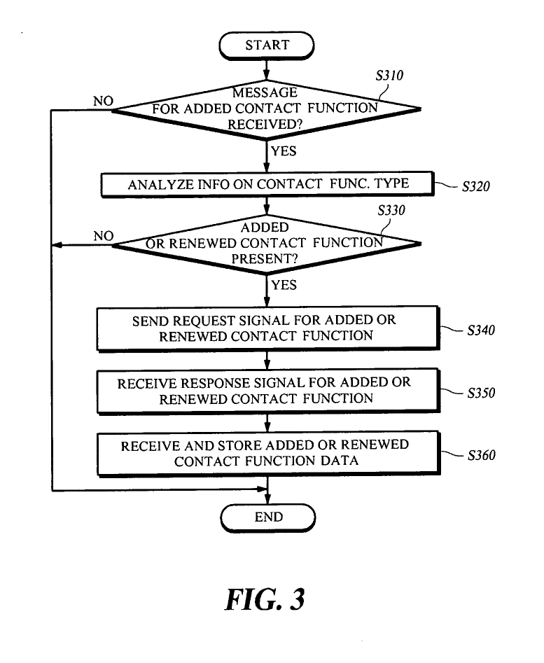

FIG. 3 is a flow chart for illustrating a method for mobile communication terminal 110 of the first aspect to receive and apply add or update data.

Communication server 130 periodically sends the message of added contact function to mobile communication terminal 110 via mobile communication network 120.

Mobile communication terminal 110 checks for receipt of a message of an added contact function from communication server 130 via mobile communication network 120 in step S310.

If step S310 finds the message from communication server 130, mobile communication terminal 110 analyzes information of the contact function in the data field of the message of an added contact function in step S320.

Here, the contact function information is to identify the added contact function, and may comprise information of at least one of Activate Talk Function, Activate Connection to Internet, Activate SMS, Activate MMS, and Activate Application as shown in Table 1.

TABLE 1

| Type | Parameter 1 | Parameter 2 |
|---|---|---|
| Activate Talk Function | Mobile Number | None |
| Activate Connection to Internet | ip or domain Name | path or file path |
| Activate Connection to Internet | ip or domain Name | port or port/path |
| Activate SMS | Mobile Number | Service Definition |
| Activate MMS | Mobile Number | Service Definition |
| Activate Application | AID | Service Definition |

Mobile communication terminal 110 checks if there is an add or update contact function in step S330.

That is, mobile communication terminal 110 uses the contact function information to see if menus in the list of icons of the contact functions have the add or update contact function.

For example, mobile communication terminal 110 in the event of the contact function information being ‘Activate SMS’ checks for an add or update contact function about the short message service among list of icons of the contact functions.

Meanwhile, if mobile communication terminal 110 does not have an application corresponding to the contact function information it analyzed, it makes a connection to communication server 130 to download the application capable of implementing a function corresponding to the contact function information.

If step S330 finds an event of the add or update contact function, mobile communication terminal 110 sends a request signal for add or update contact functions to communication server 130 in step S340.

Here, the request signal for add or update contact functions comprises information on one or more of a terminal model code, a display size, and a list version of contact function icons.

TABLE 2

| | Length | Value | |
|---|---|---|---|
| Tag | (byte) | Type | Description |
| model_code | | S | Terminal Model Code |
| lcd_size | | S | Display Size |
| func_icon_list_ver | 4 | I32 | Version of List Contact |
| | | | Func. Icons |

Mobile communication terminal 110 receives a response signal to add or update contact functions from communication server 130 in step S350.

Here, the response signal to add or update contact functions comprises information on one or more of command status string, list version of contact function icons, contact function icon notice WAP or WEB page, list count of contact function icons, variable count of listed elements, contact function icon name, contact function icon type, short text informative help, long text informative help, focused image of icons, unfocused image of icons, and download URL, as shown in Table 3.

TABLE 3

| | Length | Value | |
|---|---|---|---|
| Tag | (byte) | Type | Description |
| command_status_text | | S | Text Corresponding to |
| | | | Command Status |
| func_icon_list_ver | 4 | I32 | List Version of Contact |
| | | | Function Icons |
| func_icon_noti_page_url | | S | Contact Function Icon |
| | | | Notice WAP or |
| | | | WEB Page |
| func_icon_list_count | 2 | I16 | Lists Count of Contact |
| | | | Function Icons |
| variable_count | 2 | I16 | Variables Count of |
| | | | Listed Elements |
| func_icon_name | | S | Contact Function Icon |
| | | | Name |
| func_icon_type | 1 | C | Contact Function Icon |
| | | | Type, Its Setting Helps |
| | | | Selective Setting |
| | | | between Basic Icons and |
| | | | Added Icons |
| func_icon_help_short_text | | S | Short Text Informative |
| | | | Help |
| func_icon_help_long_text | | S | Long Text Informative |
| | | | Help |
| func_icon_focus_image | | B | Focused Image of Icons |
| | | | (content-type: png) |
| func_icon_unfocus_image | | B | Unfocused Image |
| | | | of Icons |
| | | | (content-type: png) |
| func_icon_dl_url | | S | Downloaded URL |
| func_icon_parameter | | S | DLF PARAMETER |
| . . . | . . . | . . . | . . . |

Mobile communication terminal 110 receives and stores additional/updated data corresponding to the add or update contact function in step S360.

That is, mobile communication terminal 110 receives the additional/updated data and applies the same to optional menu list 718 on contact function edit mode 710.

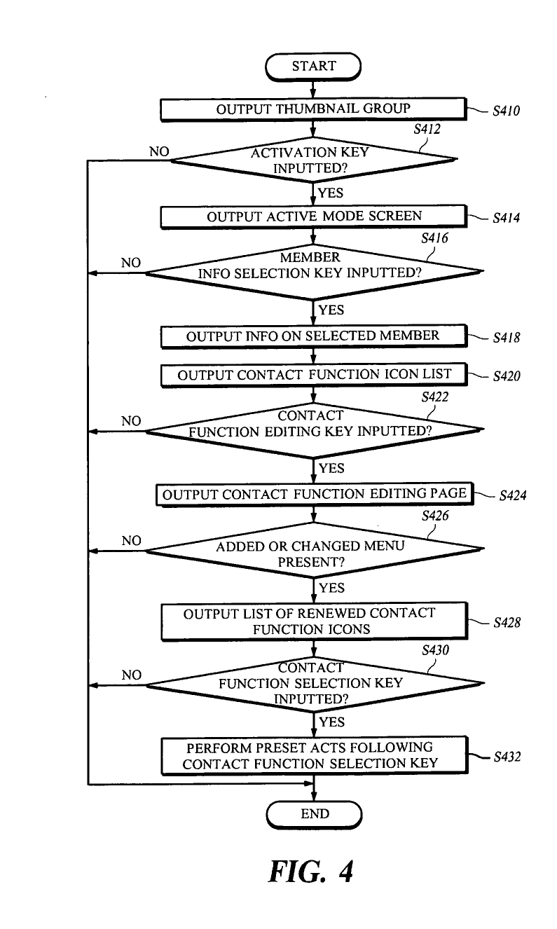

FIG. 4 is a flow chart for illustrating a method for mobile communication terminal 110 of the first aspect to update and output the contact function menu.

Mobile communication terminal 110 outputs idle screen 510 on display 220 and also outputs at an area of idle screen 510 a thumbnail group 520 having thumbnails 522 by the corresponding amount to the preset slots in step S410.

Mobile communication terminal 110 checks whether there is a preset activation key inputted from key input unit 230 in step S412.

For example, assuming the preset activation key is a ‘cancel key’, the mobile communication terminal is adapted to determine if the user operates key input unit 230 to enter the ‘cancel key’.

When step S412 finds the preset activation key inputted, the terminal outputs active mode screen 550 that displays member icons of one or more members of frequent contacts 540 matching thumbnail group 520 in step S414.

Here, the member icon includes member's image information 524, name information 526, or both.

The mobile communication terminal checks if a preset member selection key is inputted from key input unit 230 in step S416.

For example, assuming the preset member selection key is left/right arrow keys', the terminal determines if the user had an operation on key input unit 230 to input the left/right arrow keys'.

When step S416 finds the preset member selection key inputted, terminal 110 outputs the selected icon of member among frequent contacts 540 in step S418.

Here, the icon of member includes member's image information 524, name information 526, or both.

Mobile communication terminal 110 outputs contact function icon list 530 for the selected icon of member in step S420.

Mobile communication terminal 110 checks if a preset contact function editing key is inputted from key input unit 230 in step S422.

When step S422 finds the preset contact function editing key inputted, mobile communication terminal 110 outputs contact function edit mode 710 in step S424.

That is, mobile communication terminal 110 is adapted to output contact function edit mode 710 comprising information of at least one of a title area 712, text area 714, basic menu list 716, and optional menu list 718.

Mobile communication terminal 110 checks if added or changed menu 810 is present in contact function edit mode 710 in step S426.

If step S426 checks the event of added or changed menu 810, mobile communication terminal 110 outputs updated contact function icon list 820 that is contact function icon list 530 with added or changed menu 810 applied thereto in step S428.

Mobile communication terminal 110 checks if a preset contact function selection key is inputted for updated contact function icon list 820 from key input unit 230 in step S430.

For example, assuming the preset member selection key is ‘up/down arrow keys’, the terminal determines if the user had an operation on key input unit 230 to input the ‘up/down arrow keys’.

Here, since updated contact function icon list 820 comprises at least one of the voice call menu, SSM menu, MMS menu, data format type message menu, MIM menu, mobile homepage menu, email menu, personal homepage, and PC remote control menu, the user input of the ‘up/down arrow keys’ with key input unit 230 selects the menu icon of the corresponding one of the voice call menu, SSM menu, MMS menu, data format type message menu, MIM menu, mobile homepage menu, email menu, personal homepage, and PC remote control menu.

When step S430 finds the preset contact function selection key inputted, terminal 110 carries out a preset operation according to the contact function selection key in step S432.

That is, when the user inputs the ‘up/down arrow keys’ with key input unit 230 with the accordingly selected icon is assumed to be a ‘voice call icon’, the mobile communication terminal can make a call to the phone number corresponding to selected member icon, whereas assuming the selected icon is a ‘SMS icon’, the mobile communication terminal can output a page from which SMS is sent to the phone number corresponding to selected member icon.

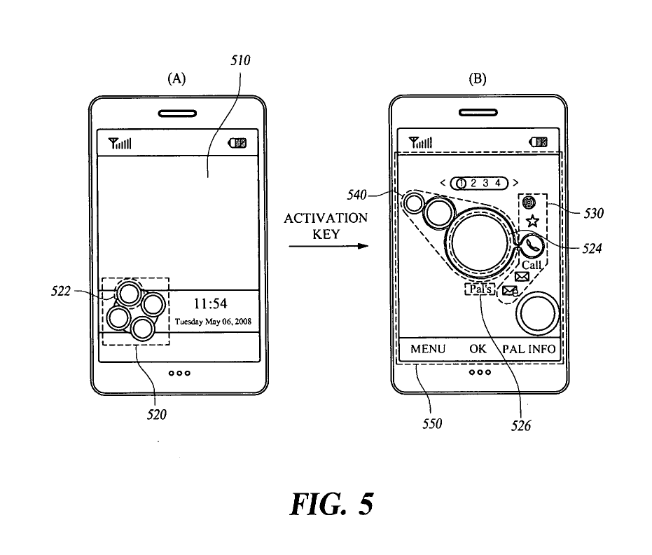

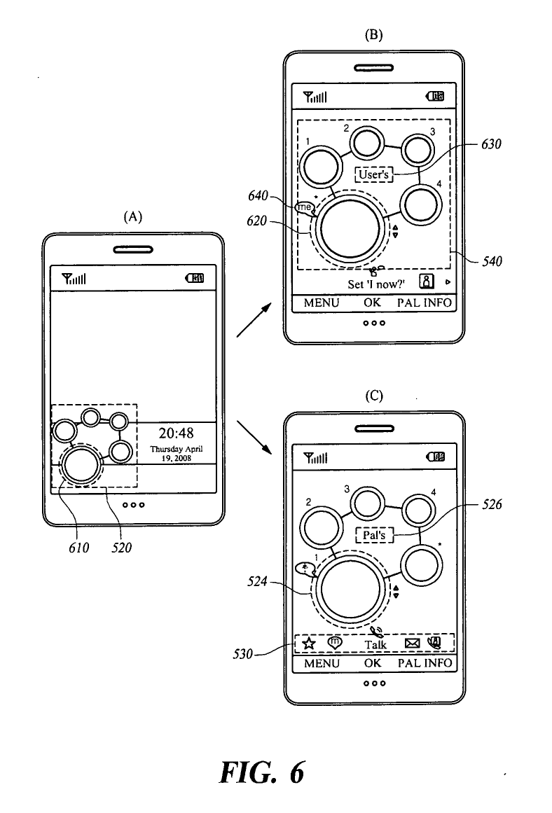

FIGS. 5 and 6 are exemplary diagrams of an idle screen and an active mode screen according to the first aspect.

As shown in FIG. 5 at (A), outputted on idle screen 510 are images that users like such as their own photos, friends' photos, or their preferred images including those of Internet-downloaded celebrities, cars, etc. or videos.

According to an aspect, along with the user's set image or video on idle screen 510, the terminal outputs thumbnail group 520 containing thumbnails 522 of the corresponding number to a preset number of slots on a certain portion of idle screen 510.

The position of thumbnail group 520 in FIG. 5 at (A) is merely to illustrate the technical idea of the disclosure, and it may be varied within idle screen 510 by a person skilled in the technical area of the present disclosure without departing from the essential characteristics of the disclosure.

In addition, upon inputting the preset activation key in the state of FIG. 5 at (A), active mode screen 550 as in FIG. 5 at (B) is outputted.

Active mode screen 550 contains member's image information 524, name information 526, frequent contacts 540, contact function icon list 530, etc.

Member image information 524 may be set using a photograph, avatar, or character, and edited by the user through a soft key. In addition, image information 524 may be set with partners' photos received or shared through wireless communication processor 270.

Members' name information 526 represents an area to output the user's name data registered with frequent contacts 329 and it may show the member's name and group name registered with a directory of numbers in the terminal.

Frequent contacts 524 match the preset slot number of thumbnail group 520 and is a group containing icons of the user's preset members.

Contact function icon list 530 is an area to provide various icons in a list for allowing contacts with other subscribing users corresponding to the selected member icons.

Meanwhile, as shown in FIG. 6 at (A), mobile communication terminal 110 may additionally display thumbnail 610 of user's image information on thumbnail group 520.

In addition, upon inputting the preset activation key in the state of FIG. 6 at (A), mobile communication terminal 110 may provide an active mode screen containing frequent contacts 540 with the user information added, and display identifier information 640 on active mode screen 350 to differentiate the user information from the preregistered member icons in FIG. 6 at (B).

Here, the user's own information may contain user's own image information 620 and name information 630, or both as shown in FIG. 6 at (B).

Additionally, in order to differentiate user's own image information 620 from the preregistered members' image information, mobile communication terminal 110 may add a distinctive borderline color or pattern, which is distinctive from the preregistered members' image information.

Further, on the active mode screen as in FIG. 6 at (B), when the preset contact function selection key ('up/down arrow keys') is inputted, it is possible to output member icons preregistered with frequent contacts 540 and contact function icon list 530.

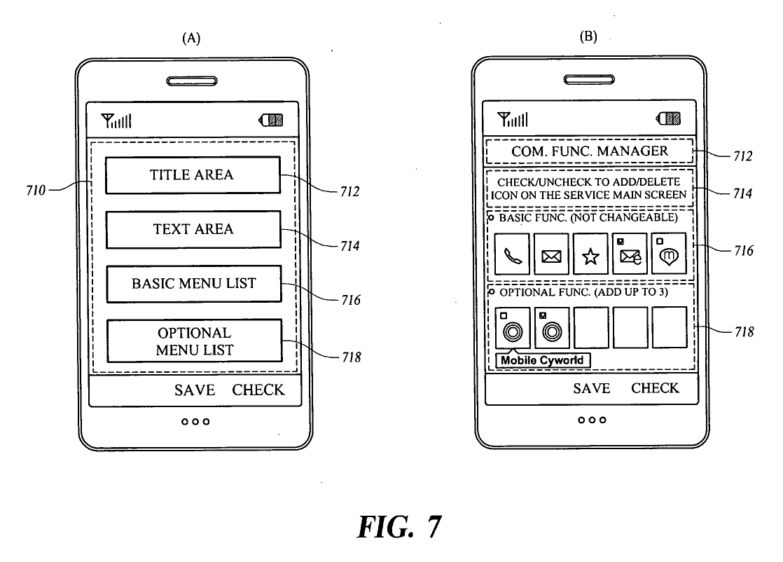

FIG. 7 is an exemplary diagram of a contact function edit mode according to the first aspect.

When the user inputs the preset contact function editing key, mobile communication terminal 110 outputs contact function edit mode 710 as shown in FIG. 7 at (A).

Contact function edit mode 710 comprises title area 712, text area 714, basic menu list 716, and optional menu list 718.

Title area 712 is for showing the title for contact function edit mode 710, and may display ‘COMMUNICATION FUNCTION MANAGER’ as in FIG. 7 at (B).

Text area 714 is for outputting informative help text for the contact function editing, and may display a comment such as ‘CHECK/UNCHECK TO ADD/DELETE ON THE MAIN SCREEN’ as shown in FIG. 7 at (B).

Basic menu list 716 may be reserved for outputting the basic menu of contact function icon list 530, and comprised of a preset number of basic menu slots, and under control of mobile communication terminal 110, is kept intact from added or changed menu 810 as is true with the basic menu contained in the basic menu slots.

On the other hand, basic menu list 716 provides check and uncheck boxes for the basic menu in the basic menu slots under control of mobile communication terminal 110 as shown in FIG. 7 at (B).

Here, the basic menu in the basic menu slots comprises at least one of the voice call menu, SSM menu, MMS menu, data format type message menu, and MIM menu.

Optional menu list 718 is for outputting an optional menu of contact function icon list 530, and comprised of a preset number of optional menu slots with the added or changed menu 810 applied thereto for outputting under control of mobile communication terminal 110, or the optional menu in the optional menu slots may be replaced by the added or changed menu 810.

In addition, the optional menu in the optional menu slots may comprise at least one menu of the mobile homepage menu, email menu, personal homepage, and PC remote control menu.

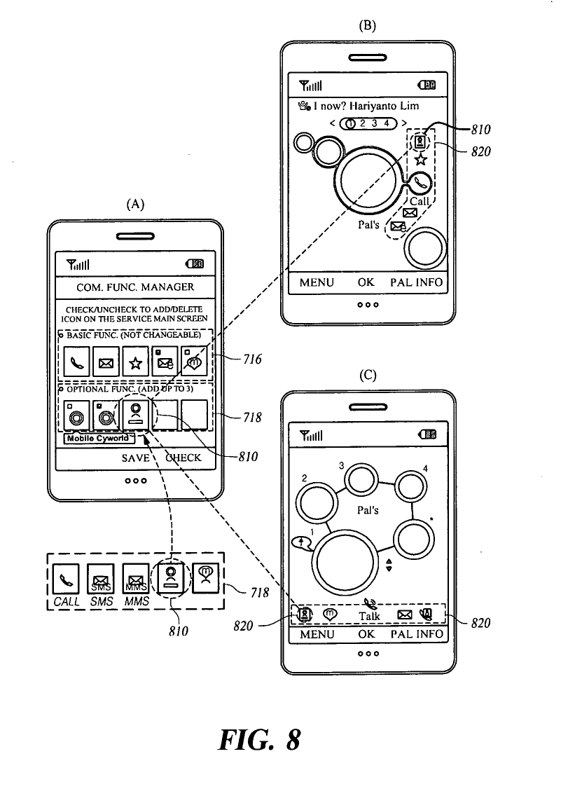

FIG. 8 is an exemplary diagram of an updated list of icons of the contact functions according to the first aspect.

As shown in FIG. 8, in response to the added or changed menu 810, mobile communication terminal 110 outputs updated contact function icon list 820 with the added or changed menu 810 applied thereto; and in response to a contact function selection key input for updated contact function icon list 820, performs the action plans set with the contact function selection key.

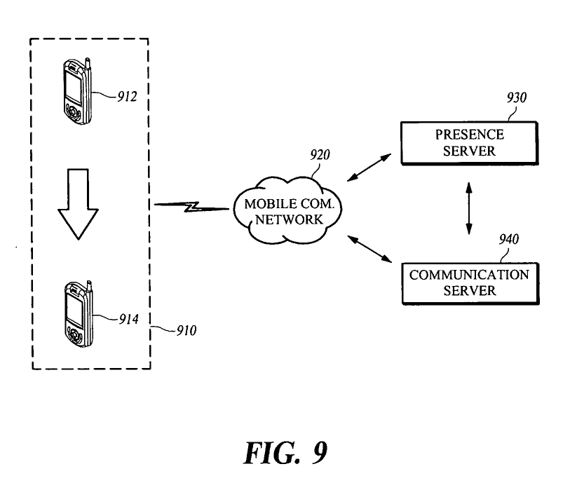

FIG. 9 is a schematic block diagram for showing a system for providing a presence service according to a second aspect.

The presence service provision system of the second aspect includes a mobile communication terminal 910, a mobile communication network 920, a presence server 930, and a communication server 940.

Mobile communication terminal 910 means a terminal for carrying out typical wireless communications of voice call and data communication in association with mobile communication network 920.

Mobile communication terminal 910 may be classified into a first mobile communication terminal 912 and a second mobile communication terminal 914 which share common mobile communication subscriber information but have different terminal identification numbers. That is, mobile communication terminal 910 depicted in FIG. 9 is intended to encompass the first and second mobile communication terminals 912 and 914 wherein the first terminal 912 may be defined as a subscriber's terminal before alternation and the second terminal 914 as a replacement terminal of the same subscriber after alternation.

In addition, mobile communication terminal 910 has an installation of a communication program 1114 for carrying out the communications.

Mobile communication terminal 910 follows communication program 1114 to output a thumbnail group 1520 of thumbnails 1522 of the corresponding number to a preset number of slots on a certain portion of an idle screen 1510 and, if a preset activation key is inputted, turn the screen to an active mode screen for displaying among matching frequent contacts 1528 with thumbnail group 1520 at least one member's icon and calling partner's status information 1530, and if a preset member selection key is inputted, output among frequent contacts 1528 the selected member's icon and this partner's status information.

Mobile communication terminal 910 performs to output user's own status information 1540 on a certain portion of active mode screen 1550.

Mobile communication terminal 910, upon receiving a preset status information change key to change user's own status information 1540, turns the screen to a status information change page and then sets inputted information as updated status information and outputs it as user's status information 1540.

Mobile communication terminal 910, in response to the setting of the updated status information, supplies communication server 940 with a transport signal for sending the updated status information to the partners' terminals preregistered with frequent contacts 1528.

Upon receiving a status information change signal, mobile communication terminal 910 controls to change the selected member's icon and the partner's status information to member's icon and the partner's status information received and corresponding to the status information change signal.

In addition, mobile communication terminal 910 outputs a preset vibration or audio notice once it receives the status information change signal.

In addition, mobile communication terminal 910, in respond to a key input for deactivating the notice, keeps the vibrations or audio notice inactive even after receiving the status information change signal while applying the received partner's status information onto active mode screen 1550. For example, when the user does not want to be bothered in the night from the status information change signal causing the vibrations or audio notice, the notice deactivation key may be inputted to stop generating the vibrations or audio notice even at the receipt of the status information change signal.

In addition, mobile communication terminal 910 outputs an animation effect associated with the received party's status information. For example, mobile communication terminal 910 may make the changed status information of the calling partner in the frequent contacts 1528 noticeable by providing conspicuously rendered characters with an animated firework effect.

In addition, mobile communication terminal 910 outputs a preset vibration or audio notice depending on when it receives the status information change signal. Mobile communication terminal 910 responses to a receipt of the status information change signal in the night for limiting the vibrations and audio notice from being issued, but it applies the received status information onto active mode screen 1550.

Additionally, thumbnail group 1520 displayed on idle screen 1510 of mobile communication terminal 910 has thumbnails 1522 equally numbered to preset slots and connected in a vertical or horizontal oval shape. Mobile communication terminal 910 rotates thumbnail group 1520 clockwise or counterclockwise to move the corresponding thumbnail to the status information change signal into a preset location within thumbnail group 1520. Here, the preset location may be the uppermost or lowermost in thumbnail group 1520.

In addition, mobile communication terminal 910 temporarily outputs the received partner's status information on idle screen 1610. Mobile communication terminal 910 has the relocated thumbnail at the preset location blink temporarily.

Mobile communication terminal 910, upon receiving one or more status information change signals, rotates thumbnail group 1520 clockwise or counterclockwise to move the thumbnail corresponding to the last status information change signal received into a preset location within thumbnail group 1520.

In addition, mobile communication terminal 910, upon receiving the preset activation key inputted, outputs the active mode screen for displaying the received member's icon and partner's status information as a home screen.

Upon receiving one or more status information change signals, mobile communication terminal 910 sequentially applies one or more partners' status information received onto its active mode screen in which the member's icon and partner's status information corresponding to the last received status information change signal among the status information change signals is outputted as a home screen.

In addition, mobile communication terminal 910, at the initial output of the home screen, temporarily blinks the selected member icon or partner's status information outputted on the home screen. Therefore, if the user missed checking the received partner's status information in active mode screen 1550, briefly blinking the selected member icon or partner's status information outputted first on the home screen will facilitate identifying the partner's status information received but unchecked from similar information checked already.

Mobile communication terminal 910 also outputs a contact function icon list 1560 for the selected member icon or received member icon and, in response to the input of the contact function selection key for contact function icon list 1560, performs a operation preset for the key. Here, the contact function icon list includes one or more of a voice call icon, an SMS icon, an MMS icon, and an MIM icon.

Here, the partner's status information may comprise one or more of status information image icons, commonly used phrases and texts, and 8-character texts or a combination of these, and the partner's status information may include one or more of member image information 1524, member name information 1526, and telephone number information.

Mobile communication terminal 910 also outputs, on the active mode screen, user's own information added to frequent contacts 1528. On the active mode screen, mobile communication terminal 910 displays identifier information 1650 for differentiating user's own information from the preregistered member icons with frequent contacts 1528.

Here, the user's own information includes one or more of user's own image information 1620, name information 1630, and user's status change information 1640 which includes an editing function of the user's photo or a changing function of the user's status.

In addition, mobile communication terminal 910 performs rendering of user's own image information 1620 in a distinctive borderline color or pattern from preregistered member image information for a further differentiation therebetween.

Mobile communication network 920 represents a network connected by wireless with mobile communication terminal 910 for carrying out various functions that serve voice call, wireless data, wireless Internet, video call, or messaging communications.

According to a second aspect, presence server 930 controls to receive and store a presence message containing communication information on a current status from the first mobile communication terminal 912, and if there is an update of the communication information of first mobile communication terminal 912, receive and analyze an updated presence message of the updated communication information sent from first mobile communication terminal 912, generate latest communication information having the updated communication information applied to the previously stored communication information, and upon receiving a presence request signal due to a terminal alternation from a second mobile communication terminal 914, transmit a presence response signal containing the latest communication information to second mobile communication terminal 914.

In addition, presence server 930 in the second aspect checks if the subscriber of second mobile communication terminal 914 is identical to the first mobile communication terminal 912 subscriber, and if yes, it controls to send the presence response signal to second mobile communication terminal 914.

The communication information of the disclosure may be defined as all the information generated in the course of registering information of the member of the frequent contacts or the owner user and outputting the individual's status information, although for the purpose of descriptive convenience the communication information herein is defined as one of the calling partner's member icon, calling partner's status information, owner information, and owner status information.

Presence server 930 in the second aspect inquires of first mobile communication terminal 912 whether there is a change in the member icon or the user's information, and if there were such change, it receives an updated presence message containing the changed member icon or the changed owner information from first mobile communication terminal 912 and applies the same change in the member icon or owner information to latest communication information.

Presence server 930 in the second aspect inquires of first mobile communication terminal 912 whether there is a change in partner's status information 1530 or owner status information 1540, and if there were such change, it receives an updated presence message containing the changed partner status information or the changed owner status information from first mobile communication terminal 912 and applies the same change in the partner status information or owner status information to the latest communication information.

Here, partner status information 1530 or owner status information 1540 may be combined information of one or more of status information image icons, commonly used phrases, and texts.

In addition, the member icon may include one or more of member image information 1524, member name information 1526, telephone number, and email information, while the owner information may include user's image information 1620 and/or user's name information 1630.

Presence server 930 in the second aspect, upon receiving a request from the contacted partner' terminal for outputting member image information 1524 or user's image information 1620, checks whether the same information 1524 or 1620 is permitted for sharing, and if sharable, allows outputting member image information 1524 or user's image information 1620.

Here, member's image information 1524 or user's image information 1620 may be one of a photograph, avatar image, and character image.

Presence server 930 in the second aspect, upon receiving a service unsubscription signal from first mobile communication terminal 912 or second mobile communication terminal 914, deletes the previously stored latest communication information after a preset period elapsed. In implementation of the disclosure, the preset period is preferably six months.

Presence server 930 in the second aspect, upon receiving the presence request signal from first mobile communication terminal 912, transmits the presence response signal containing the latest communication information to first mobile communication terminal 912.

Here, the presence request signal may comprise information of one or more of Info Fetch Type, Preregistered Member Icon MDN, and Fetching Category Info as in Table 4, and Info Fetch Type may be one of the entire fetch types of the preregistered member icons, a specific member's icon fetch type, and owner's information fetch type.

TABLE 4

| | | Length | Value | |
|---|---|---|---|---|
| Pres. | Tag | (byte) | Type | Description: Settable |
| m | fetch_type | 1 | C | Info Fetch Type, as |
| | | | | Overall/Specific Member/User Info |
| o | buddy_mdn | | S | as Preregistered Member |
| | | | | Info MDN |
| o | filter | | S | Fetching Category Info, May Be |
| | | | | Assigned Up To 16 Bytes |

In addition, the presence response signal may comprise at least one of Command Status Text, Info Fetch Type, Price Plan Subscription/Non-Subscription, Status Info Text of User Info, User Info Icon Setting Mask, Preregistered Member Icon List Version, Preregistered Member Icon Lists Count, Variables Count of Listed Elements, Preregistered Member Icon MDN, Slot Number, Member Name Info, and Member Image Info Type as in Table 5.

TABLE 5

| | | Length | Value | |
|---|---|---|---|---|
| Pres. | Tag | (byte) | Type | Description: Settable |
| m | command_status_text | | S | as Command Status Text |
| m | fetch_type | 1 | C | Info Fetch Type, as Overall/Specific Member/User Info |
| m | registration_type | 1 | C | Subscription Data For Price Plan, as Data for A |
| | | | | Plan-Unsubscribed or Plan-Subscribed Person |
| o | status_text | | S | as Status Info Text of User Info |
| o | func_icon_mask | | S | as User Info Icon Setting Mask |
| o | buddy_list_ver | 4 | I32 | as Preregistered Member Info List Version |
| o | buddy_list_count | 2 | I16 | as Preregistered Member Info Lists Count |
| o | variable_count | 2 | I16 | as Variables Count of Listed Elements |
| o | buddy_mdn | | S | as Preregistered Member Info MDN |
| o | slot_number | 2 | I16 | as Slot Number |
| o | status_text | | S | as Status Info Text |
| o | buddy_nickname | | S | as Member Name Info |
| o | buddy_picture_type | 1 | C | Member Image Info Type, as Code or Data for Identifying |
| | | | | Avatar/Picture |
| o | buddy_avatar_code | 2 | I16 | Data by Member Image Info Type, as Avatar Code |
| o | buddy_photo_binary | | B | Data by Member Image Info Type, as Picture Data |
| o | display_mask | 2 | I16 | Item Display Setting Bit Mask, as Data for Identifying |
| | | | | Nickname or Status Info Text |
| o | e_mail | | S | as E-mail Address |
| . . . | . . . | . . . | . . . | . . . |

Communication server 940 receives status information change signal from mobile communication terminal 910, extracts information of one or more partners' terminals which are preregistered with frequent contacts 1528 as mobile communication terminals 910, and provides the terminals corresponding to the extracted partner terminal information with the status information change signal.

In addition, communication server 940 provides the terminals corresponding to the partner terminal information with a consent message for sharing the status information, and upon receiving an approval signal for the sharing consent message from the terminals corresponding to the partner terminal information, transmits the status information change signal to the terminals corresponding to the partner terminal information.

In addition, communication server 940 provides the respective terminals corresponding to the information of one or more partner terminals preregistered with frequent contacts 1528 with the sharing consent message once every time.

In addition, communication server 940 performs to cancel the sharing consent for a terminal unregistered from frequent contacts 940.

In addition, communication server 940 performs to send a user name change signal or a status selection signal to the terminals corresponding to the partner terminal information.

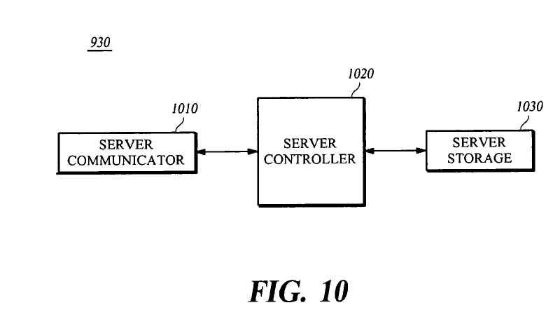

FIG. 10 is a schematic block diagram for showing presence server 930 according to the second aspect.

Presence server 930 of the second aspect includes a server communicator 1010, a server controller 1020, and a server storage 1030.

However, the components of server communicator 1010, server controller 1020, and server storage 1030 of presence server 930 are illustrative only and they may be changed and modified without departing from the intrinsic characteristics of the disclosure in the technical field of the disclosure.

Server communicator 1010 is a communicating means which cooperates with mobile communication terminals 910 including first terminal 912 and second terminal 914 via mobile communication network 920, and performs to send and receive various data.

Server control 1020 according to the second aspect is a total server function control for controlling server communicator 1010 to receive and store the presence message containing the current status of communication information from first mobile communication terminal 912, and if there is an update of the communication information of first mobile communication terminal 912, receive and analyze an updated presence message containing the update of the communication information, generate latest communication information having the updated communication information applied to the prestored communication information, and upon receiving a presence request signal due to a terminal alternation from second mobile communication terminal 914, transmit a presence response signal containing the latest communication information to second mobile communication terminal 914.

In addition, server control 1020 in the second aspect checks if subscriber information of second mobile communication terminal 914 is identical to subscriber information of the first mobile communication terminal 912, and if yes, it controls to send the presence response signal to second mobile communication terminal 914.

Server control 1020 in the second aspect inquires of first mobile communication terminal 912 whether there is a change in the member icon or the owner's information, and if there were such change, it receives an updated presence message containing the changed member icon or the changed owner information from first mobile communication terminal 912 and applies the same change in the member icon or owner information to latest communication information.

Server control 1020 in the second aspect inquires of first mobile communication terminal 912 whether there is a change in partner's status information 1530 or owner status information 1540, and if there were such change, it receives an updated presence message containing the changed partner status information or the changed owner status information from first mobile communication terminal 912 and applies the same change in the partner status information or owner status information to the latest communication information.

Server control 1020 in the second aspect, upon receiving a request from the contacted partner' terminal for outputting member image information 1524 or user's image information 1620, checks whether the same information 1524 or 1620 is permitted for sharing, and if it is found sharable, allows outputting member image information 1524 or user's image information 1620.

Server control 1020 in the second aspect, upon receiving a service unsubscription signal from first mobile communication terminal 912 or second mobile communication terminal 914, deletes the previously stored latest communication information after a preset period elapsed. In implementing the disclosure, the preset period is preferably six months.

Server control 1020 in the second aspect, upon receiving the presence request signal from first mobile communication terminal 912, transmits the presence response signal containing the latest communication information to first mobile communication terminal 912.

On the other hand, server controller 1020 may operate with an equipment of computer-readable recording medium recording a program for implementing functions to receive and store a presence message containing communication information on a current status from first mobile communication terminal 912 in order to execute communication server 940, check if communication information of first mobile communication terminal 912 is updated and if so, receive and analyze an updated presence message containing the updated communication information sent from first mobile communication terminal 912, generate latest communication information having the updated communication information reflected to the previously stored communication information, receive a presence request signal due to a terminal alternation sent from second mobile communication terminal 914 having the same mobile communication subscriber information as but a different terminal identification number from those of first mobile communication terminal 912, and transmit a presence response signal containing the latest communication information to second mobile communication terminal 914.

Server storage 1030 is a means for storing various data needed for operating the server, and performs to store information of one or more of a presence message, updated presence message, communication information, and latest communication information.

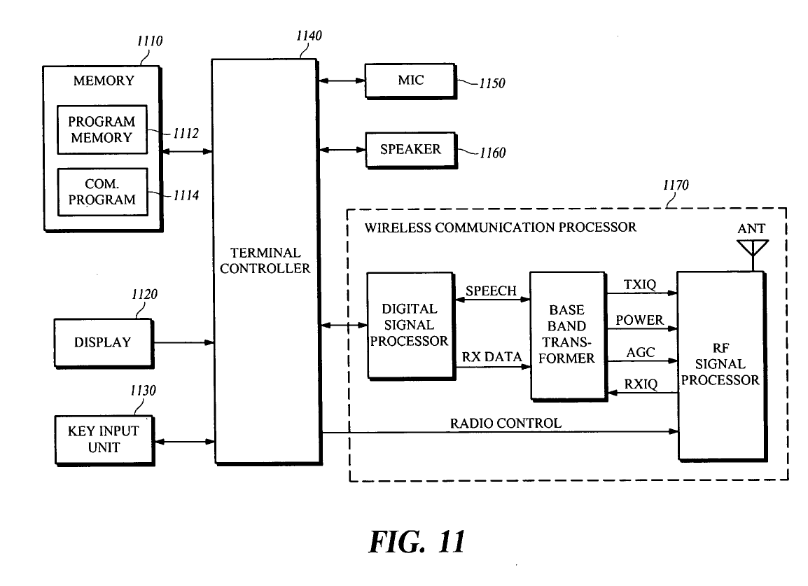

FIG. 11 is a schematic block diagram for showing a mobile communication terminal according to the second aspect.

As explained with reference to FIG. 9, since mobile communication terminal 910 is conceptualized to encompass first mobile communication terminal 912 and second mobile communication terminal 914, these terminals 912 and 914 are commonly referred to as mobile communication terminal(s) 910.

Mobile communication terminal 910 includes a memory 1110, display 1120, key input unit 1130, terminal controller 1140, microphone 1150, speaker 1160, and wireless communication processor 1170.

Although the presently disclosure recites that the mobile communication terminal includes memory 1110, display 1120, key input unit 1130, terminal controller 1140, microphone 1150, speaker 1160, and wireless communication processor 1170, it is only illustrative and the mobile communication terminal components may be changed and modified for application as needed by a person skilled in the art.

Memory 1110 is a means for storing basic software for driving mobile communication terminal 110 and performing voice and data communications, a number of software programs for carrying out various extra functions including a camera feature, and protocol software for processing messages transmitted and received to perform wireless communications and the like.

Memory 1110 temporarily stores data generated throughout executing a terminal control program or stores user's input data, and it may be composed of a program memory 1112 for controlling the general operation of the mobile communication terminal and a communication program 1114 for outputting frequent contacts 1528 or partner status information 1530.

Here, communication program 1114 is so defined that it is an application installed in the mobile communication terminal, provides a page setting where user's frequent contact members or one or more acquaintances of interest may be grouped, functions to output the thumbnails for the graphic image information of the group members on the idle screen, rendering one or more thumbnail outputs on the idle screen as a single group, functions to reposition the thumbnails based on information of the members with changed status and, in response to an activation key input, helps facilitate recognizing the members with changed status.

Active mode screen 1550 is so defined herein commonly referring to a displayed page for setting user's frequent contact members or one or more acquaintances of interest; a page for outputting set members' image, name, and phone number information; and a page for outputting partner's status information and owner's status information which are provided by communication program 1114.

In addition, frequent contacts 1528 are so defined and described as a group set composed of user's frequent contact members or one or more acquaintances of interest in communication program 1114.

In addition, thumbnail group 1520 is so defined and described as thumbnails of image information expressed as a group on an idle screen area out of information of the respective members in the frequent contacts 1528. That is, thumbnail group 1520 is an idle screen area displaying only thumbnails out of members' information set with the frequent contacts 1528.

Display 1120 shows the state of operation of the mobile communication terminal including the usage of a power source, the strength of the radio signal reception, date, and time, and it becomes a display means for outputting information delivered in the forms of characters, numbers, images, etc.

Under terminal controller 1140, display 1120 also visualizes messages generated during the execution of the various programs stored in memory 1110 and messages generated throughout the execution of communication program 1114.

Input unit 1130 is a key input means provided with numerical buttons, character input button, menu selection buttons and the like for receiving key inputs or commands from the mobile communication terminal user.

Terminal controller 1140 is to control the overall operations of the mobile communication terminal and executes the various programs stored in memory 1110 for not only the basic function of voice and data communications according to inputted signals from input unit 1130 or wireless communication processor 1170 but also added functions. In addition, upon receiving data having no immediacy in execution, terminal controller 1140 has such data sent to and stored in memory 1110.

Terminal controller 1140 follows communication program 1114 to output a thumbnail group 1520 of thumbnails 1522 of the corresponding number to a preset number of slots on a certain portion of idle screen 1510 and, if a preset activation key is inputted, turn the screen to an active mode screen 1550 for displaying among matching frequent contacts 1528 with thumbnail group 1520 at least one member icon and calling partner status information 1530, and if a preset member icon selection key is inputted, output among frequent contacts 1528 the selected member icon and partner status information.

Terminal controller 1140 performs to output owner status information 1540 on a certain portion of active mode screen 1550. Terminal controller 1140, upon receiving a preset status information change key to change owner status information 1540, turns the screen to a status information change page and then sets inputted information as updated status information and outputs it as owner status information 1540.

Terminal controller 1140, in response to the setting of the updated status information, supplies communication server 940 with a transport signal for sending the updated status information to the partners' terminals preregistered with frequent contacts 1528. Upon receiving a status information change signal, terminal controller 1140 controls to change the selected member's icon and the partner's status information to member's icon and the partner's status information received and corresponding to the status information change signal.

In addition, terminal controller 1140 outputs a preset vibration or audio notice once it receives the status information change signal. In addition, terminal controller 1140 responds to a key input for deactivating the notice for keeping the terminal mute from the vibrations or audio notice even after receiving the status information change signal while applying the received partner's status information onto active mode screen 1550.

In addition, terminal controller 1140 outputs an animation effect associated with the received partner's status information. Terminal controller 1140 performs to output the preset vibrations or audio notice depending on the time when the status information change signal is received.

In addition, terminal controller 1140 responses to a receipt of the status information change signal in the night for limiting the vibrations and audio notice from being issued, but it applies the received status information onto active mode screen 1050. Additionally, thumbnail group 1520 displayed on idle screen 1010 of terminal controller 1140 has thumbnails 1522 equally numbered to preset slots and connected in a vertical or horizontal oval shape.

In addition, terminal controller 1140 rotates thumbnail group 1020 clockwise or counterclockwise to move the corresponding thumbnail to the status information change signal into a preset position within thumbnail group 1520. Here, the preset position may be the uppermost or lowermost in thumbnail group 1520.

Terminal controller 1140 temporarily outputs the received partner's status information on idle screen 1510. Terminal controller 1140 has the relocated thumbnail at the preset position blink temporarily.

In addition, terminal controller 1140, upon receiving at least one status information change signal, rotates thumbnail group 1520 clockwise or counterclockwise to move the corresponding thumbnail to the last status information change signal received into a preset position within thumbnail group 1520.

In addition, terminal controller 1140, upon receiving the preset activation key inputted, outputs the active mode screen for displaying the received member icon and partner's status information as a home screen.

In addition, terminal controller 1140, upon receiving one or more status information change signals, sequentially applies one or more partners' status information received onto its active mode screen in which the member icon and partner's status information corresponding to the last received one of the status information change signals is outputted as a home screen.

In addition, terminal controller 1140, at the initial output of the home screen, temporarily blinks the selected member icon or partner's status information outputted on the home screen.

In addition, terminal controller 1140 also outputs a contact function icon list 1560 for the selected member icon or received member icon and, in response to the input of the contact function selection key for contact function icon list 1560, performs a preset operation for the key. Here, the contact function icon list includes one or more of a voice call icon, an SMS icon, an MMS icon, and an MIM icon.

Terminal controller 1140 also performs to add owner information to frequent contacts 1528 and display both on the active mode screen. Terminal controller 1140 displays identifier information 1650 for differentiating the owner information from the member icons preregistered with the frequent contacts.

In addition, terminal controller 1140 performs rendering of owner image information 1620 in a different borderline color or pattern from preregistered member image information for a further differentiation therebetween. Terminal controller 1140 additionally incorporates thumbnail 1610 for owner image information into thumbnail group 1520.

Microphone 1150 is a voice input means adapted to transform a mobile communication subscriber's voice input into an electric signal to supply. Speaker 1160 is a means for transforming the supplied voice signal into audible sounds to output.

Wireless communication processor 1170 is a means for processing wireless communications by performing a digital signal processing function including audio signal coding/decoding, an equalizer feature for canceling a multipath noise, and audio data processing; a baseband transform function including a transform of transmitted/received signals to the baseband signals and a digital-to-analog and analog-to-digital transforms; an RF signal processing function including receiving and transforming a radio frequency (RF) signal to an intermediate frequency (IF) signal, transforming the IF signal to RF signal, and demodulating and amplifying the RF signal; and an antenna function for transmitting and receiving wireless signals over the air.

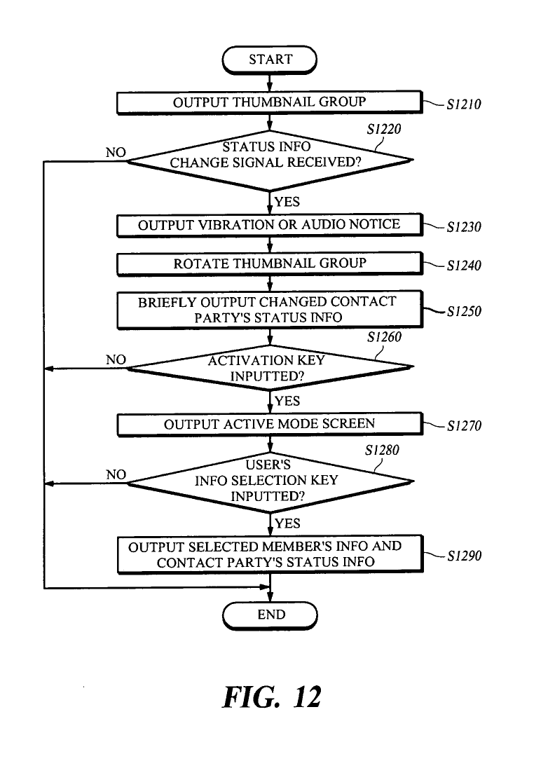

FIG. 12 is a flow chart for illustrating a method for the mobile communication terminal of the second aspect to output contact member information and share status information.

Mobile communication terminal 910 outputs idle screen 1510 and follows communication program 1114 to output a thumbnail group 1520 of thumbnails 1522 of the corresponding number to a preset number of slots on a certain portion of an idle screen 1510 in step S1210.

Mobile communication terminal 910 checks if there is a status information change signal received from communication server 940 in step S1220.

If step S1220 finds the status information change signal received, mobile communication terminal 910 outputs a vibration or audio notice depending on when it receives the status information change signal in step S1230.

Mobile communication terminal 910 rotates thumbnail group 1520 clockwise or counterclockwise to move the corresponding thumbnail to the status information change signal into a preset position within thumbnail group 1520 in step S1240.

Mobile communication terminal 910 temporarily outputs the partner's status information on a certain portion of idle screen 1510 in step S1250.

For example, partner's status information 1530 outputted on idle screen 1510 may be moved from the left to right and then faded out.

Mobile communication terminal 910 checks if a preset activation key is inputted in step S1260.

For example, assuming the preset key is a ‘cancel key’, mobile communication terminal 910 determines if the user operates input to enter the ‘cancel key’.

When step S1260 finds the preset activation key input, mobile communication terminal 910 outputs active mode screen 1550 that displays its home page of member icon and partners' status information received and corresponding to the status information change signal in frequent contacts 1528 matching with thumbnail group 1520 in step S1270.

Mobile communication terminal 910 checks if a preset member selection key is inputted in step S1280.

For example, assuming the preset member selection key is ‘left/right arrow keys’, mobile communication terminal 910 determines if the user had an operation on input for the ‘left/right arrow keys’.

When step S1280 finds the preset member icon selection is inputted, mobile communication terminal 910 outputs selected member icon and partners' status information in frequent contacts 1528 in response to the member icon selection key in step S1290.

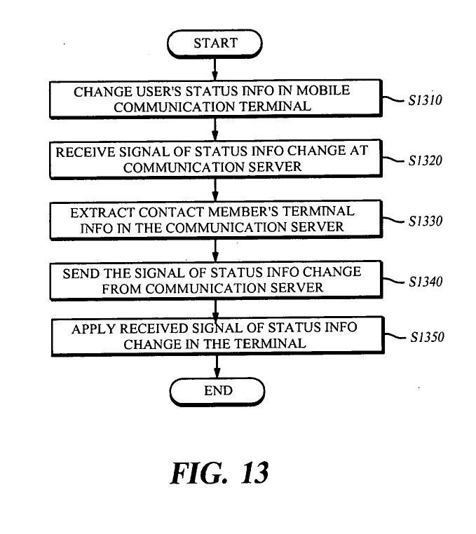

FIG. 13 is a flow chart for illustrating a method for a communication server of the second aspect to share status information.

Mobile communication terminal 910, upon receiving a preset status information changing key at its input unit to change the owner status information 1540, turns the screen to a status information change page for setting incoming information as updated status information before outputting it as the owner status information 1540 in step S1310.

For example, assuming the preset status change key is ‘*’, mobile communication terminal 910 responds to ‘*’ inputted for turning the screen to the status information change page and then sets the inputted information as the updated status information for outputting the same for owner status information 1540.

If mobile communication terminal 910 outputted owner status information 1540 set as the updated status information, it provides communication server 940 with the status information change signal for transmitting the updated status information to member terminals preregistered with frequent contacts 1528 in step S1320.

Upon receiving the status information change signal from mobile communication terminal 910, communication server 540 extracts one or more partner terminals' information that preregistered mobile communication terminal 910 with frequent contacts 1028 in step S1330.

Communication server 940 sends the status information change signal to mobile communication terminal 910 corresponding to the partner terminal information extracted in step S1340.

Mobile communication terminal 910 corresponding to the partner terminal information, upon receiving a status information change signal from communication server 940, controls to change the received member icon and partner status information corresponding to the status information change signal in step S1350.

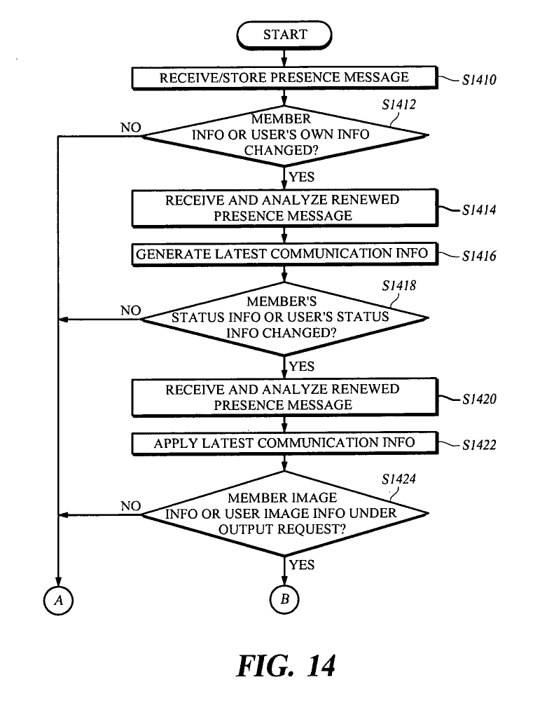

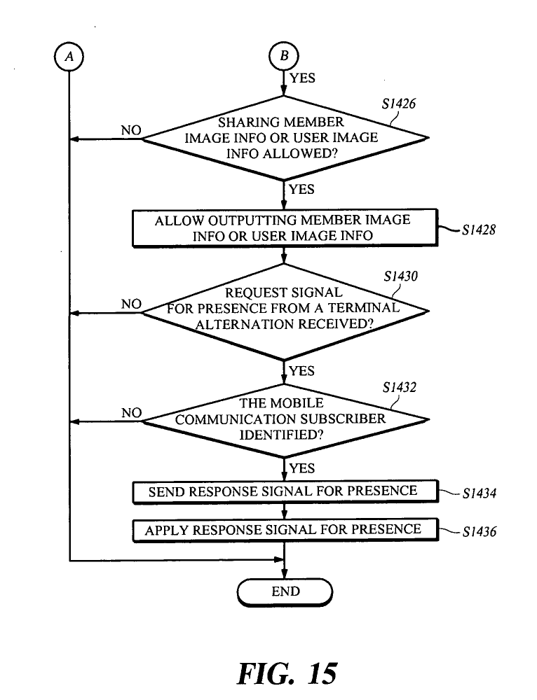

FIGS. 14 and 15 are a flow chart for showing a method for the presence server of the second aspect to provide the presence service.

Presence server 930 receives and stores a presence message containing a current status of communication information from first mobile communication terminal 912 in step S1410.

Here, since the communication information contains at least one of the member icon, owner information, partner information 1530, and owner status information 1540, presence server 930 is supposed to store at least one of the member icon, owner information, partner information 1530, and owner status information 1540.

Presence server 930 inquires of first mobile communication terminal 912 if there is a change in the member's icon or the owner's information in step S1412.

If step S1412 finds there is a change in the member icon or owner information, presence server 930 receives and analyzes an updated presence message containing the changed member icon or changed owner information sent from first mobile communication terminal 912 in step S1414.

Presence server 930 generates latest communication information having the changed member icon or changed owner information reflected in the previously stored communication information in step S1416.

Presence server 930 inquires of first mobile communication terminal 912 if there is a change in partner status information 1530 or owner status information 1540 in step S1418).

If step S1418 finds there is a change in partner status information 1530 or owner status information 1540, presence server 930 receives and analyzes an updated presence message containing the changed partner status information or changed owner status information in step S1420.

Presence server 930 reflects the changed partner status information or changed owner status information in latest communication information in step S1422.

Presence server 930 checks whether there is a request from the contacted partner' terminal for outputting member image information 1524 or owner image information 1620 in step S1424.

If step S1424 finds that there is such request for outputting member image information 1524 or owner image information 1620, presence server 930 checks whether the same information 1524 or 1620 is permitted for sharing in step S1426.

If step S1426 finds that information 1524 or 1620 is sharable, presence server 930 allows outputting member image information 1524 or owner image information 1620 in step S1428.

Presence server 930 checks if there is a presence request signal received due to a terminal alternation from second mobile communication terminal 914 in step S1430.

If step S1430 finds that the presence request signal is received, presence server 930 checks if the subscriber to second mobile communication terminal 914 is identical to first mobile communication terminal 912 subscriber in step S1432.

If step S1432 finds that those subscribers are identical, presence server 930 sends a presence response signal containing the latest communication information to second mobile communication terminal 914 in step S1434.

Second mobile communication terminal 914 receives the presence response signal and reflects the latest communication information in the presence response signal in step S1436.

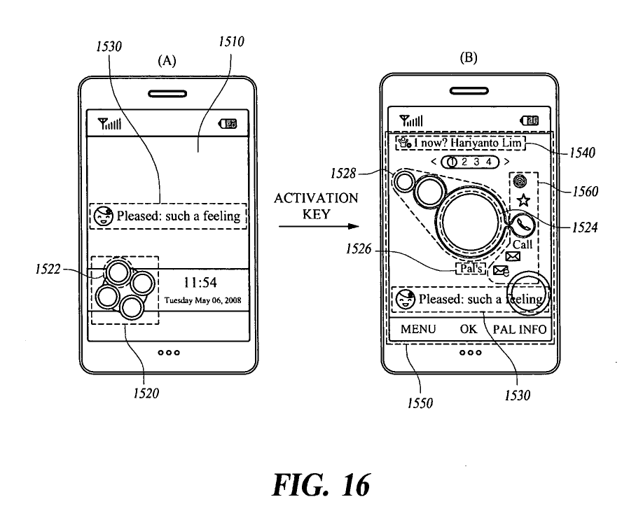

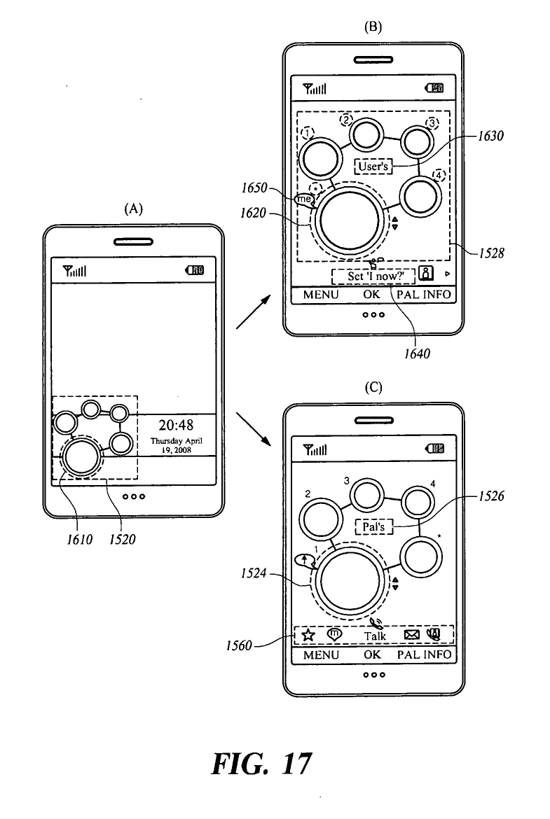

FIGS. 16 and 17 are exemplary diagrams of the mobile communication terminal according to the second aspect.

As shown in FIG. 16 at (A), outputted on idle screen 1510 are images that users like such as their own photos, friends' photos, or their preferred images including those of Internet-downloaded celebrities, cars, etc. or videos.

Along with the user's set image or video on idle screen 1510, mobile communication terminal 910 outputs thumbnail group 1520 containing thumbnails 1522 of the corresponding number to a preset number of slots on a certain portion of idle screen 1510.

The position of thumbnail group 1520 in FIG. 16 at (A) is merely to illustrate the technical idea of the disclosure, and it may be varied within idle screen 1510 by a person skilled in the technical area of the present disclosure without departing from the essential characteristics of the disclosure.

Meanwhile, if the status information change signal is received, the thumbnail corresponding to the status information change signal may be rotated into a preset position as at A of FIG. 16 within thumbnail group 1520 by rotating thumbnail group 1520 clockwise or counterclockwise.

In addition, if the status information change signal is received, the relocated thumbnail at the preset position as A of FIG. 16 may blink temporarily, and the received partner status information 1530 may be temporarily outputted on idle screen 1510.

Specifically, received partner status information 1530 may be moved from the left to right and then faded out within a certain time as shown in FIG. 16A and it may comprise combinations of status information image icons, commonly used phrases, and 8-character texts.

In addition, if a preset activation key is inputted to the state of FIG. 16A, active mode screen 1550 as in FIG. 16B is outputted.

Active mode screen 1550 contains member image information 1524, member name information 1526, frequent contacts 1528, partner status information 1530, and owner status information 1540.

Member image information 1524 may be set using a photograph, avatar, or character, and member name information 1526 may be an area to output name information of the user registered with frequent contacts 1528, and the name to output may be a preregistered name or nickname in the phone directory of the mobile communication terminal.

Frequent contacts 1528 are a group of members matching in number with the preset slots of thumbnail group 1520, and include the user's preset members.

Owner status information 1540 is an area to display user's own status as in FIG. 16 at B, and if the preset status information change key (‘*’ key) is inputted therein, the terminal may turn the screen to information change page and then set the inputted information as an updated status information for outputting the same as the owner status information 1540.

Contact function icon list 1560 is an area to provide a list of various icons through which the individual user corresponding to the selected member icon or the received member icon may be contacted, and if a preset contact function selection key is inputted therein, a preset operation is performed depending on the contact function selection key.

For example, assuming the preset contact function selection key is the ‘up/down arrow keys’, inputting thereof will select from contact function icon list 1560 one of its included voice call icon, SMS icon, MMS icon, and MIM icon.

Specifically, if the user inputted ‘up/down arrow keys’ and thus selected the ‘voice call icon’, the terminal may transmit voice calls to the phone number corresponding to the user's selected member icon, and if the selection is the ‘SMS icon’, such terminal may transmit SMS to the phone number corresponding to the user's selected member icon.

Meanwhile, as shown in FIG. 17 at (A), mobile communication terminal 910 may add thumbnail 1610 for owner information to thumbnail group 1520 and display both.

In addition, upon inputting the preset activation key in the state of FIG. 17 at (A), mobile communication terminal 910 may provide an active mode screen containing frequent contacts 1528 with the owner information added, and display identifier information 1650 on an active mode screen to differentiate the owner information from the preregistered member icons as shown in FIG. 17 at (B).

Here, the owner information may contain information of one or more of user's own image information 1620, name information 1630, and owner status change information 1640 as shown in FIG. 17 at (B), and owner status change information 1640 may include an owner picture editing function or owner status change function.

Additionally, in order to differentiate user's own image information 1620 from the preregistered members' image information, mobile communication terminal 910 may add a borderline color or pattern which is distinctive from the preregistered members' image information.

Further, on the active mode screen as in FIG. 17 at (B), when the preset contact function selection key (‘up/down arrow keys’) is inputted, it is possible to output member icons preregistered with frequent contacts 1528 and contact function icon list 1560 as in FIG. 17 at (C).

In addition, as shown in FIG. 17 at (B), shortcut key information 1660 is matching information with member icons and owner information preregistered with frequent contacts 1528, and it may be outputted on a certain portion of active mode screen 1550 as shown in FIG. 17 at (B).

For example, shortcut information 1660 may be outputted on active mode screen 1550 in the form of ‘*, 1, 2, 3 and 4’ located above the member icons and owner information preregistered with frequent contacts 1528. In particular, the member icon is paired with ‘*’ and outputted, and preregistered member icons may be paired with ‘1, 2, 3 and 4’ and outputted.

In addition, if there is a receipt of a key corresponding to shortcut key information 1660 from key input unit 1130, it is possible to rearrange the member icon or owner information preregistered with frequent contacts 1528 and paired with the key corresponding to shortcut key information 1660 so that it is centrally located.

In particular, if the user depresses ‘3’ among shortcut information 1660 of ‘*, 1, 2, 3 and 4’, the member icon paired with ‘3’ may be centered by a clockwise or counterclockwise rotation of the member icon and owner information preregistered with frequent contacts 1528.

On the other hand, as shown in FIG. 17 at (A), the mobile communication terminal may additionally display thumbnail 1610 for the owner image information onto thumbnail group 1520.

Although exemplary aspects of the present disclosure have been described for illustrative purposes, those skilled in the art will appreciate that various changes and modifications are possible, without departing from the essential characteristics of the disclosure. Therefore, exemplary aspects of the present disclosure have been described not for limiting purposes. The scope of the disclosure for protection is to be interpreted by the claims attached, and each and every claim equivalent should be interpreted as being included in the claim scope.

### INDUSTRIAL APPLICABILITY

As described above, the present disclosure helps to facilitate contacting acquaintances even further by making an icon list of contact functions editable with an addition, deletion, or correction, and when applied to a method for providing communication functions for frequent contacts, and a mobile communication terminal and a presence server for the same, the present disclosure practically offers diverse contacting functions via terminals at user's option.

### CROSS-REFERENCE TO RELATED APPLICATION

This application claims the priorities under 35 U.S.C §119(a) of Korean Patent Application No. 10-2008-0074789, filed on Jul. 30, 2008 and Korean Patent Application No. 10-2008-0076167, filed on Aug. 4, 2008 in the KIPO (Korean Intellectual Property Office), the disclosures of which are incorporated herein in their entirety by reference.

1. A mobile communication terminal comprising:
a storage for storing a communication program for registering frequent contacts;
a display for outputting the communication program;
a key input unit for receiving an input of a key or a command; and
a controller for executing the communication program to display icons of members registered with the frequent contacts, output a list of contact function icons for a selected member in the frequent contacts, and perform the contact function corresponding to a contact function selection from an updated list of the contact function icons with respect to a selected member, wherein the updated list includes an added or changed contact function that is made in a contact function edit mode.

2. The mobile communication terminal of claim 1, wherein the controller receives a message for added contact function from a communication server, and adds or updates the list of the contact function icons based on an identification of a data field of the message for added contact function.

3. The mobile communication terminal of claim 2, wherein, if an application corresponding to a contact function being added or updated according to the message for added contact function is not loaded, the controller downloads and installs an application for performing the corresponding contact function from the communication server.

4. The mobile communication terminal of claim 2, wherein the controller identifies the added contact function through information on the contact function contained in the data field of the message for the added contact function.

5. The mobile communication terminal of claim 4, wherein the controller, in response to the information on contact function, applies one or more functions out of executions of voice call function, Internet connecting function, SMS function, and MMS function to the list of icons of the contact functions.

6. The mobile communication terminal of claim 2, wherein the controller sends a request signal for an add or update mode to the communication server and then receives a response signal for the add or update mode from the communication server to thereby reflect the response signal to the list of the contact function icons.

7. The mobile communication terminal of claim 6, wherein the controller sends the request signal for an add or update mode carrying information on one or more of a terminal model code, a display size, and a list version of contact function icons, to the communication server.

8. The mobile communication terminal of claim 6, wherein the controller, in response to the response signal for an add or update mode, applies information on one or more of command status string, list version of contact function icons, notice of contact function icons on WAP or WEB page, list count of contact function icons, variable count of listed elements, name of contact function icons, type of contact function icons, short text help, long text help, focused image of icons, unfocused image of icons, and download URL, to the list of contact function icons.

9. The mobile communication terminal of claim 1, wherein the controller, upon receiving an activation command from the input unit, turns the display to an active mode for displaying graphic image information of the frequent contacts.

10. The mobile communication terminal of claim 1, wherein the controller sends a presence message to a presence server, the presence message containing communication information about a current status along with a presence request signal, and then receives a presence response signal including latest communication information from the presence server to apply the presence response signal to the frequent contacts.

11. The mobile communication terminal of claim 10, wherein the controller, in an event of an update of an information on the current status of a user icon, user's own information, contact party's status information, and/or user's own status information, sends an updated presence message containing the update of the information on the current status.

12. The mobile communication terminal of claim 10, wherein the server controller sends, to the presence server, a presence request signal in response to an alternation of terminal and then receives a presence response signal including latest communication information from the presence server to apply the presence response signal to the frequent contacts.

13. The mobile communication terminal of claim 10, wherein the server controller provides an access to the presence server for setting up an allowance check for sharing the presence message to permit allowed members to exclusively receive the presence message.

14. A presence server comprising:
a server communicator interworking with mobile communication terminals sharing common mobile communication subscriber information but having different terminal identification numbers;
a server controller for receiving and storing a presence message containing communication information on a current status from a first mobile communication terminals, generating latest communication information by receiving an updated presence message containing an update of the current status from the first mobile communication terminals and by applying the update to previously stored communication information, and transmitting a presence response signal containing the latest communication information to a second mobile communication terminal upon receiving a presence request signal from the second mobile communication terminal; and
a server storage for storing one or more of the presence message, the communication information, and the latest communication information.

15. The presence server of claim 14, wherein the server controller deletes previously stored latest communication information after a prescribed period elapses.

16. A method for providing communication functions for a communication terminal to frequent contacts comprising:
executing a communication program for registering the frequent contacts to display icons of members registered with the frequent contacts;
outputting a list of contact function icons for a selected member in the frequent contacts; and
performing a contact function corresponding to a contact function selection from an updated list of the contact function icons with respect to a selected member, wherein the updated list includes an added or changed contact function that is made in a contact function edit mode.

17. The method of claim 16, further comprising, receiving a message for added contact function from a communication server, and adding or updating the list of the contact function icons based on an identification of a data field of the message for added contact function.

18. The method of claim 17, further comprising, if an application corresponding to the contact function being added or updated according to the message for added contact function is not loaded, downloading and installing an application for performing the corresponding contact function from the communication server.

19. The method of claim 16, further comprising:
sending a presence server a presence message containing communication information on a current status and an updated current status; and
sending, to the presence server, a presence request signal and then receiving a presence response signal including latest communication information from the presence server to apply the presence response signal to the frequent contacts.

20. The method of claim 19, further comprising, sending, to the presence server, a presence request signal in response to an alternation of terminal and then receiving a presence response signal including latest communication information from the presence server to apply the presence response signal to the frequent contacts.
